(19) United States
(12) Patent Application Publication
(10) Pub. No.: US 2007/0272295 A1
(43) Pub. Date: Nov. 29, 2007

(54) Heat sink for photovoltaic cells

(76) Inventors: Leonid B. Rubin, Burnaby (CA); Valery M. Nebusov, Burnaby (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/441,532

(22) Filed: May 26, 2006

(51) Int. Cl. H02N 6/00

(52) U.S. Cl. 136/246

(57) ABSTRACT

An apparatus and method are for holding heat generating elements such as solar cells. The apparatus includes a body and a component mounting surface for mounting a heat generating component, such as a solar cell, thereon. The apparatus can further include a plurality of spaced apart heat transfer element holders that are configured to transfer heat from the body to heat transfer elements. The apparatus can also include a connector that is configured to cooperate with a corresponding connector of an adjacent apparatus to mechanically couple the body to the adjacent apparatus while allowing for thermal expansion the body relative to the adjacent apparatus, thereby producing a linear array.

### BACKGROUND OF THE INVENTION

1. Field of Invention

This invention relates to heat dissipation and more particularly to heat dissipation from a solar cell or a plurality of solar cells.

2. Description of Related Art

Photovoltaic sun concentrators used with photovoltaic (PV) solar cells provide a way of making solar electric energy cost competitive compared to conventional electric generation technologies such as fossil fuels. Although concentrators have been known for years, to date they have not demonstrated economic feasibility. One reason for this is that the concentration of the sun's energy creates heat and thus it is necessary to cool photovoltaic solar cells that are exposed to concentrated solar radiation. When PV cells and/or modules are operated under normal solar radiation of 1000 W/m² they may reach temperatures of up to 70° C.-90° C. When concentrators are used, these devices may reach temperatures of up to several hundred degrees if cooling is not provided. Such temperatures can lead to several negative effects. For example, cell efficiency decreases proportionally to temperature and electrical power output is reduced. In addition, many materials used in PV cells and/or modules have an operating temperature range that typically does not exceed +150 degrees Celsius. Therefore any photovoltaic sun concentrator system must employ a heat sink.

Photovoltaic sun concentrators are usually of two types: linear and point focusing. Linear focusing photovoltaic sun concentrators typically employ a Fresnel lens or Trough mirror optics to focus solar radiation into a narrow line along a linear array of PV cells. These PV cells may be fixed to a heat sink that dissipates heat energy either via passive convection or by active cooling employing a flowing cooling fluid such as liquid or air. The Euclides sun concentrator PV project described at
http://www.ispra.es/981130.html
   employed a linear focussing sun concentrator and a passive cooling heat sink that employed a plurality of flat spaced apart aluminum fins, for example.

Point focusing photovoltaic sun concentrators focus sun radiation into a small spot at which a solar cell is positioned. The solar cell is generally fixed to a heat sink. An example of a point focussing system is provided by Spectrolab Inc. of Sylmar Calif.

Spectrolab Inc. produces one of the most efficient solar cells for point focus sun concentrators. These solar cells are fixed to a ceramic heat sink that is actively cooled with cold water. As of May 15, 2006, information about this system was available at
http://www.spectrolab.com/TerCel/PV_Concentrator_Module.pdf.

### With this system however, a high concentration of the sun's energy is achieved, resulting in solar cell temperatures still exceeding 100° C. in spite of water cooling.

Another type of point focus PV concentrator employs flat metallic plates that operate as passive heat spreaders. As of May 15, 2006, information about a system of this type was available at
http://www.Sandia.gov/pv/docs/PVFarraysConcentrators.htm.

### Unfortunately this system has only a small heat dissipating area and is unlikely to provide efficient cooling for PV cells.

European patent EP 0542478 B1, entitled Pin Fin Heat Sink Including Flow Enhancement, to Azar Kaveh describes a heat sink comprising a plurality of metallic pins that are fixed on a common substrate. Forced air is blown through the pins to enhance cooling. This heat sink is intended for use in cooling microelectronic devices but is impractical for use with solar cells.

U.S. Pat. No. 6,807,059 B1 entitled Stud Weld Pin Fin Heat Sink to James L. Dale describes a pin fin sink that is manufactured by fusion or stud welding of pins to a base forming a continuous thermally conductive path for heat rejection. The patent describes a broad range of thermally conductive materials, fin geometry and fin spacing however the proposed designs appear to require active air flow through set of pins. The requirement for active airflow would add to the cost of producing energy in a PV concentrator application, rendering the proposed designs impractical for use in such applications.

U.S. Pat. No. 5,498,297 entitled Photovoltaic Receiver to Mark J. O'Neill et al. describes a linear photovoltaic sun concentrator that employs a linear Fresnel lens, extruded aluminum heat sink and PV array comprised of several serially connected solar cells that are attached to the heat sink by an electrically insulating Tefzel film coated with an adhesive material. A front side of the PV array is covered by Tefzel film for protection against wind, rain, snow, and other environmental conditions. This design provides a temperature differential of 10-13 degrees Centigrade between the heat sink and the PV array and provides excellent electrical insulation between PV array and the heat sink. However, the heat sink includes a solid piece of extruded aluminum with a fan of heat dissipating fins, which does not provide an efficient ratio of heat dissipating surface area to weight. As a result, the heat sink becomes excessively heavy when made with sufficient surface area to adequately cool PV cells mounted thereto. In addition, Tefzel film generally cannot provide reliable protection of the PV array against ambient moisture and abrasion.

### SUMMARY OF THE INVENTION

In accordance with one aspect of the invention, there is provided an apparatus for holding heat-generating elements such as solar cells. The apparatus includes a body having first and second opposite sides, first and second opposite ends, and a component mounting surface between the first and second opposite sides and the first and second opposite ends, for mounting a heat generating component thereon. The apparatus may further include a plurality of spaced apart heat transfer element holders for holding respective heat transfer elements such that the heat transfer elements extend outwardly on opposite sides of the body. The heat transfer element holders are operably configured to transfer heat from the body to the heat transfer elements. The body has at least one connector on at least one of the first and second opposite ends, operably configured to cooperate with a corresponding connector of an adjacent apparatus to mechanically couple the body to the adjacent apparatus while allowing for thermal expansion the body relative to the adjacent apparatus.

The holders may include recesses in the body.

The body may include an extrusion and the holders may include respective recesses in the extrusion.

The recesses may extend generally parallel to the mounting surface, between the first and second opposite sides of the extrusion.

The apparatus may further include a plurality of spaced apart heat transfer elements held by the heat transfer element holders for transferring heat from the body to an ambient fluid.

Each of the heat transfer elements may have a first portion extending outwardly from the first side of the body, a second portion extending outwardly from the second side of the body and an intermediate portion extending between the first and second portions, the intermediate portion being held in a respective recess in the body.

Each of the heat transfer elements may include a fluid contacting surface for transferring heat to the fluid.

The fluid contacting surface may include a generally curved surface.

The generally curved surface may include a cylindrical surface.

The fluid contacting surface may include a plurality of generally flat surfaces.

The connector may include a projection depending from the body in spaced apart relation relative thereto such that a space is provided between the projection and the body, whereby a projection of an adjacent similar apparatus may be received in the space to mechanically couple the body to the adjacent similar apparatus.

The projection may extend generally between the first and second sides.

In accordance with another aspect of the invention, there is provided a heat sinking solar cell apparatus including a body having first and second opposite sides, first and second opposite ends, a generally planar component mounting surface between the first and second opposite sides and the first and second opposite ends, a solar cell thermally coupled to the component mounting surface such that heat generated by the solar cell is transferred to the body, and first and second arrays of spaced apart heat transfer elements thermally coupled to the body and extending outwardly on the first and second opposite sides respectively of the body and generally parallel to the component mounting surface, for transferring heat from the body to an ambient fluid.

The body may include holders for holding the heat transfer elements.

The holders may include recesses in the body.

The body may include an extrusion and the holders may comprise respective recesses in the extrusion.

The recesses may extend generally parallel to the mounting surface, between the first and second opposite sides of the extrusion.

Each of the heat transfer elements may have a first portion extending outwardly from the first side of the body, a second portion extending outwardly from the second side of the body and an intermediate portion extending between the first and second portions, the intermediate portion being held in a respective recess in the body.

Each of the heat transfer elements may include a fluid contacting surface for transferring heat from the heat transfer element to an ambient fluid.

The fluid contacting surface may include a generally curved surface.

The generally curved surface may include a cylindrical surface.

The fluid contacting surface may include a plurality of generally flat surfaces.

The apparatus may further include at least one connector on at least one of the first and second opposite ends, operably configured to cooperate with a corresponding connector of an adjacent apparatus to mechanically couple the body to the adjacent apparatus while allowing for thermal expansion of the body relative to the adjacent apparatus.

The connector may include a projection depending from the body in spaced apart relation relative thereto such that a space is provided between the projection and the body, whereby a projection of an adjacent similar apparatus may be received in the space to mechanically couple the body to the adjacent similar apparatus.

The projection may extend generally between the first and second sides.

In accordance with another aspect of the invention, there is provided a linear heat dissipating solar cell system including a plurality of heat dissipating solar cell apparatuses as described above. Each apparatus may include connectors for connecting adjacent apparatuses together to mechanically couple the apparatuses together.

A projection of a connector on one apparatus may be received in the space of a connector of an adjacent apparatus and the projection and the space may be dimensioned to permit the projection to move in the space when the body of the apparatus or the body of the adjacent apparatus expands due to heating by a corresponding solar cell associated therewith.

Each of the plurality of heat dissipating solar cell apparatuses may be thermally coupled to a common support.

The solar cell system may further include a transparent glass sheet extending over each of the heat dissipating solar cell apparatuses.

The solar cell system may further include a lens holder coupled to the common support for holding a lens to focus light energy on the solar cells.

The lens holder may include first and second pairs of projecting supports projecting generally away from the common support, at opposite ends of the system.

The solar cell system may further include lens edge holders for holding respective edges of the lens. Corresponding projecting supports of the first and second pairs of projecting supports may support respective lens edge holders in parallel spaced apart relation relative to the common support.

The solar cell system may further include a lens held by the lens edge holders.

The lens may include a Fresnel lens. The Fresnel lens may be a linear or point focus lens, for example.

The support may include a length of square tubing having a plurality of sides having openings therein.

In accordance with another aspect of the invention, there is provided a process for dissipating heat generated by a solar cell. The process involves causing heat generated by the solar cell to be transferred to a body having first and second opposite sides and first and second opposite ends, causing heat to be transferred from the body to first and second arrays of spaced apart heat transfer elements thermally coupled to the body and extending outwardly generally parallel to the solar cell, from the first and second opposite sides respectively of the body and permitting a fluid to pass freely between and around the heat transfer elements to transfer heat from the heat transfer elements to the fluid. Heat transfer may occur through convection, for example.

Causing heat to be transferred from the body to the first and second arrays may involve causing the heat to be transferred from the body to the heat transfer elements through holders on the body for holding the heat transfer elements.

Causing the heat to be transferred through the holders may involve causing the heat to be transferred from the body to respective intermediate portions of the heat transfer elements and conducting heat from the intermediate portions to opposite end portions of respective heat transfer elements.

The process may further involve conducting heat transferred to the opposite end portions of the heat transfer elements to surfaces of the opposite end portions of the heat transfer elements.

Conducting heat transferred to the opposite end portions of the heat transfer elements to surfaces of the opposite end portions may involve conducting heat transferred to the opposite end portions to curved surfaces of the opposite end portions.

Conducting heat transferred to the opposite end portions of the heat transfer elements to surfaces of the opposite end portions may involve conducting the heat transferred to the opposite end portions to cylindrical surfaces of the opposite end portions.

The process may involve mechanically coupling together a plurality of heat dissipating apparatuses, each operably configured to carry out the process above.

Conducting the heat transferred to the opposite end portions of the heat transfer elements to surfaces of the opposite end portions may involve conducting the heat transferred to the opposite end portions to generally flat surfaces of the opposite end portions.

The process may further involve permitting bodies of the apparatuses to move relative to each other to provide for thermal expansion of the bodies.

The process may further involve permitting a first projection depending from a first body in spaced apart relation relative thereto to move in a second space provided between a second projection and a second body to provide for relative movement of the first and second bodies due to thermal expansion of at least one of the bodies while mechanically coupling the first body to the second body.

The process may further involve thermally coupling the plurality of heat dissipating solar cell apparatuses to a common support.

The process may further involve causing light to pass through a glass sheet over each of the heat dissipating solar cell apparatuses, before the light reaches the each of the heat dissipating solar cell apparatuses.

The process may further involve holding a lens in a position relative to the each heat dissipating solar cell apparatus to focus light energy on solar cells of the heat dissipating apparatuses.

Holding a lens may involve holding a lens with first and second pairs of projecting supports projecting generally away from the common support, at opposite ends of the plurality of heat dissipating solar cell apparatuses.

The process may further involve holding respective edges of the lens with respective lens edge holders supported by the first and second pairs of projecting supports.

Sun concentrators may provide cost competitive electric energy only if all components, including the PV array, optics, heat sink and tracker, are inexpensive. The present invention provides a cost effective heat sink design that is able to keep the temperature of a PV array close to the ambient air temperature thereby enabling high efficiency operation of the PV array. The heat sink provides a high ratio between its heat dissipating area and weight thereby requiring only a minimum amount of material for manufacturing and enabling non-complicated and cost effective manufacturing. The heat sink design provided herein enables reliable and simple integration with PV arrays, linear and point focusing optics and tracking mechanisms and provides for protection of PV arrays, against environmental conditions.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of an apparatus for holding heat generating elements according to a first embodiment of the invention;

FIG. 2 is a perspective view of a heat sinking solar cell apparatus according to a second embodiment of the invention, incorporating the apparatus according to the first embodiment of the invention shown in FIG. 1;

FIG. 3 is a perspective view showing co-operation between respective connectors on adjacent apparatuses of the type shown in FIGS. 1 and 2;

FIG. 4 is a detailed perspective view of the co-operation between connectors shown in FIG. 3;

FIG. 5 is a perspective view of an underside of the apparatus shown in FIG. 2;

FIG. 6 is a perspective view of an underside of an apparatus according to a third embodiment of the invention;

FIG. 7 is a perspective view of a heat dissipating solar cell apparatus employing the apparatus shown in FIG. 2;

FIG. 8 is an end view of a heat dissipating solar cell apparatus according to a fourth embodiment of the invention;

FIG. 9 is a detailed perspective view of a lens edge holder of the apparatus shown in FIG. 8;

FIG. 10 is a perspective view of a heat dissipating solar cell apparatus according to a fifth embodiment of the invention employing a point focusing Fresnel lens and the apparatus shown in FIG. 7;

FIG. 11 is a detailed perspective view of a linear heat dissipating solar cell system comprising a plurality of the apparatuses shown in FIG. 7 coupled together in a linear array, covered by a common glass sheet and operable to receive sunlight through a common linear Fresnel lens; and

FIG. 12 is a perspective view of a linear heat dissipating solar cell system comprising a plurality of the apparatuses shown in FIG. 10, arranged linearly on a common support.

### DETAILED DESCRIPTION

### Extrusion

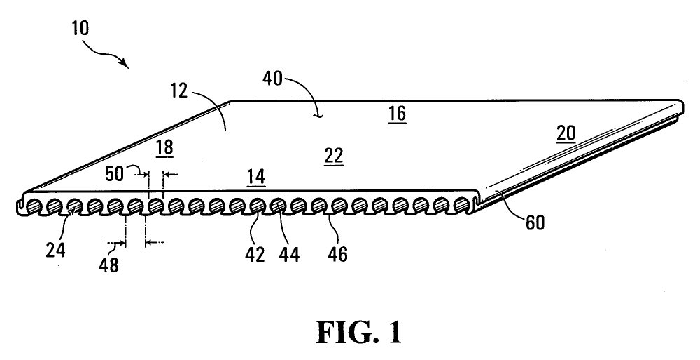

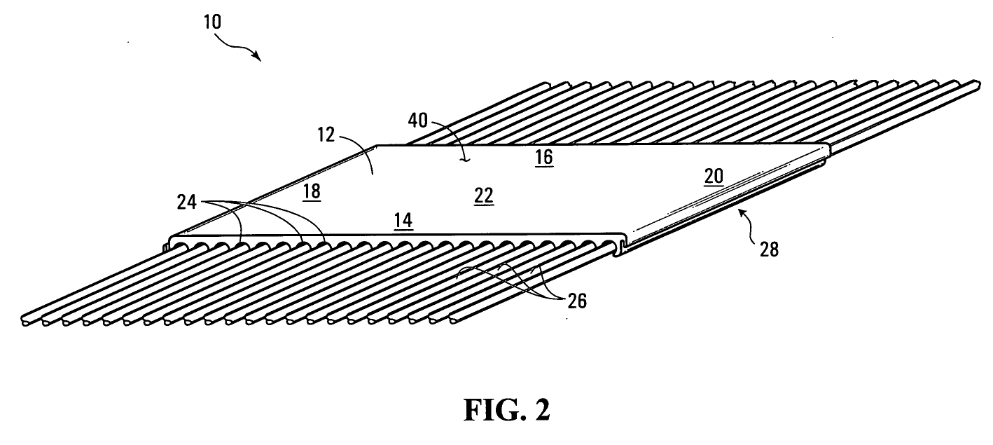

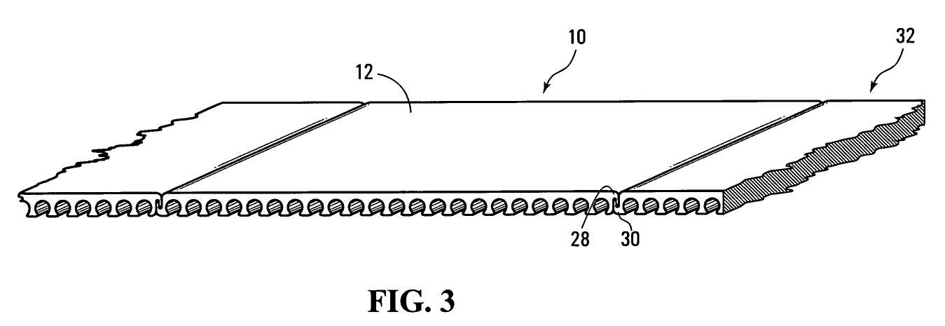

Referring to FIG. 1, an apparatus for holding heat generating elements is shown generally at 10, The apparatus comprises a body 12 having first and second opposite sides 14 and 16, first and second opposite ends 18 and 20, and a component mounting surface 22 between the first and second opposite sides and the first and second opposite ends, for mounting a heat generating component thereon. The apparatus 10 further includes a plurality of spaced apart heat transfer element holders 24 for holding respective heat transfer elements 26 such that the heat transfer elements extend outwardly on opposite sides of the body generally parallel to the component mounting surface 22 as shown in FIG. 2. The heat transfer element holders 24 are operably configured to transfer heat from the body 12 to the heat transfer elements 26. Referring to FIG. 3, the apparatus 10 further includes at least one connector 28 on at least one of the first and second opposite ends 18 or 20, operably configured to cooperate with a corresponding connector 30 of an adjacent apparatus 32 to mechanically couple the body 12 to the adjacent apparatus 32 while allowing for thermal expansion of the body 12 relative to the adjacent apparatus 32.

### Body

Referring back to FIG. 1, in the embodiment shown, the body 12 is comprised of a length of an aluminum extrusion. Extrusions formed of other metals or metal alloys with suitable thermal conductivity may be substituted. Generally, it is desirable that the body 12 be formed of a good heat conductor. In this embodiment, where the body is formed from a length of an extrusion, the extrusion is formed with a flat surface 40 on a topside and a plurality of recesses (42 and 44 being exemplary) formed lengthwise in an underside of the body 12 at the time of extruding the material. The flat surface 40 thus extends across the entire top surface of the extrusion and the recesses 42 and 44 extend in a direction of extrusion. The extrusion is cut to length for the desired application and in the embodiment shown, the extrusion may be cut into a length approximately the same as the width of the heat generating component it is intended to cool, for example.

Once the length of extrusion has been cut, ends of the length of extrusion may be used as the sides 14 and 16 of the body 12 and the sides of the length of extrusion may be used as the ends 18 and 20 of the body. Thus, a flat surface 40 of the body 12 is flat planar and acts as the mounting surface 22 and the recesses 42 and 44 extend from side 14 to side 16 of the body 12, in an underside surface 46 of the body 12, generally parallel to the mounting surface 22.

The recesses 42 and 44 act as the holders 24 for holding the heat transfer elements shown at 26 in FIG. 2. In the embodiment shown, the recesses 42 and 44 have a generally C-shaped cross section and are disposed in rows all across the sides 14 and 16 of the body 12. In the embodiment shown, the recesses 42 and 44 may have an axis to axis spacing 48 of about 4.5 mm and a diameter 50 of about 3.3 mm.

### Connector

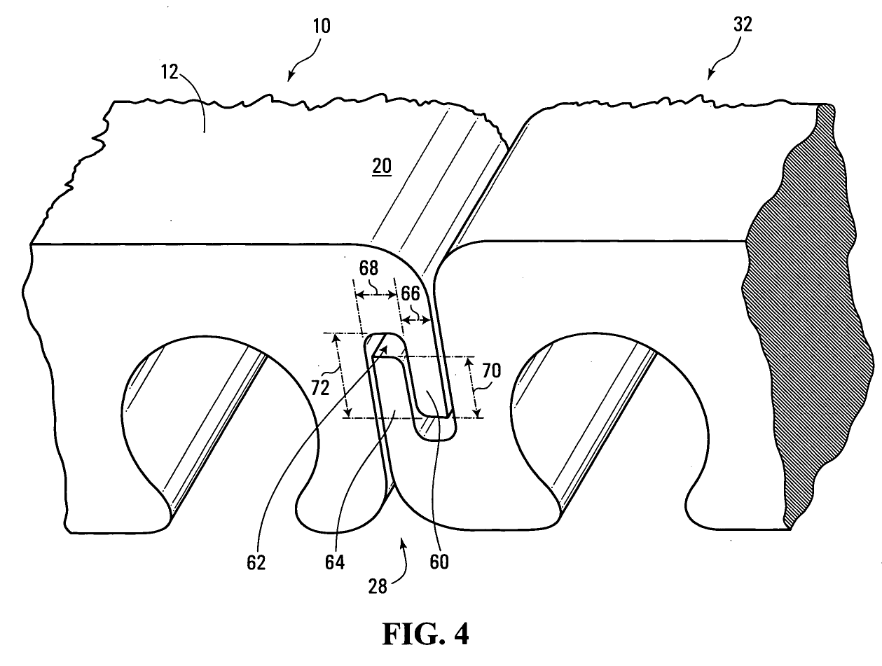

Referring to FIG. 4, the connector 28 is shown in greater detail. The connector 28 includes a projection 60 depending from the body 12 in spaced apart relation relative thereto such that a space 62 is provided between the projection 60 and the body 12. A projection 64 of an adjacent similar apparatus 32 may be received in the space 62 to mechanically couple the body 12 to the adjacent similar apparatus 32. In the embodiment shown, the projection 60 has a width 66 of about 0.5 mm and the space 62 has a width 68 of about 1 mm. The projection 64 also has a length 70 about the same as a length 72 of the space 62, approximately 1.5 mm. In the embodiment shown, the projection 60 extends all along the end portion 20, generally between the first and second sides 14 and 16, in a direction parallel to the recesses 42 and 44 as best seen in FIG. 1.

### Heat Transfer Elements

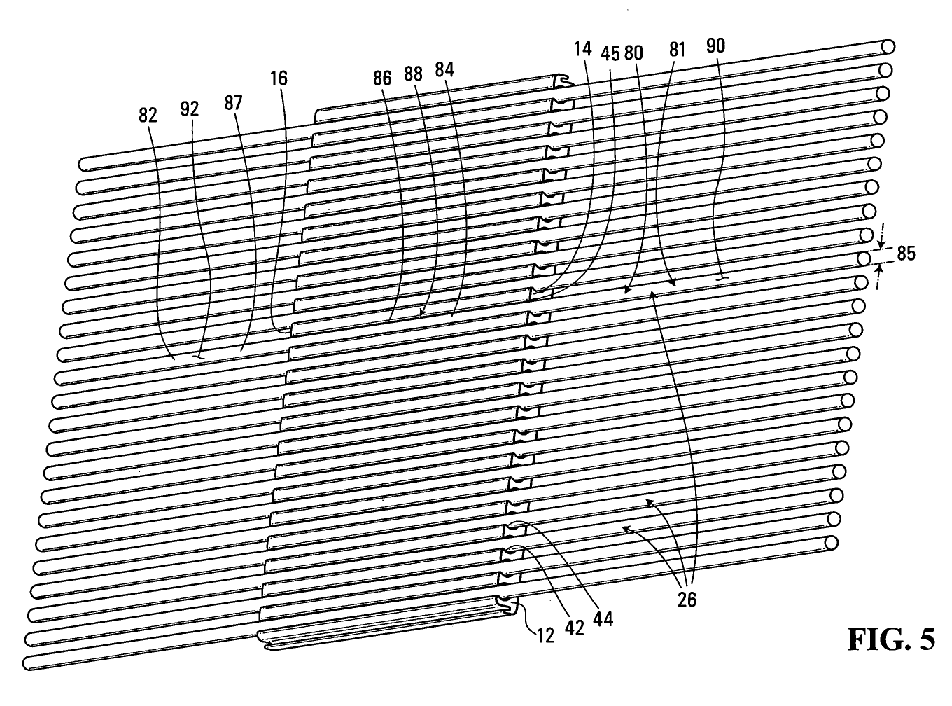

Referring to FIG. 5, the underside of the body 12 is shown with heat transfer elements 26 held in respective recesses 42 and 44. In the embodiment shown, each heat transfer element 26 is a cylindrical metallic rod 81 having a first portion 80 extending outwardly from the first side 14 of the body 12, a second portion 82 extending outwardly from the second side 16 of the body 12 and an intermediate portion 84 extending between the first and second portions 80 and 82. The intermediate portion 84 is held in a respective recess 45 in the body 12. The rods 81 have a diameter 85 approximately the same as the diameter 50 of the recesses 42, 44 and 45 and thus, the rods 81 may be pressed into the recesses 42, 44 and 45 and tightly held thereby. The tight holding of the rods 81 in the recesses 42, 44 and 45 facilitates good heat transfer between the body 12 and the rods 81 and to facilitate even better heat transfer, a low viscosity thermal conducting compound 86 such as an adhesive or low melting point alloy may be placed in gaps 88 formed by the recesses 42, 44 and 45 so that the adhesive 86 will bond a surface of the intermediate portions 84 of respective rods 81 to the body 12.

The first and second portions 80 and 82 of each rod 81 have fluid contacting surfaces 90 and 92, respectively, for transferring heat from the heat transfer element 26 to the ambient fluid. The ambient fluid may be ambient air, for example.

The fluid contacting surfaces 90 and 92 may be generally curved, for example to permit air to flow with little impedance thereabout. In the embodiment shown, the fluid contacting surfaces 90 and 92 are cylindrical, but in other embodiments, they may be elliptical, or airfoil shaped, for example.

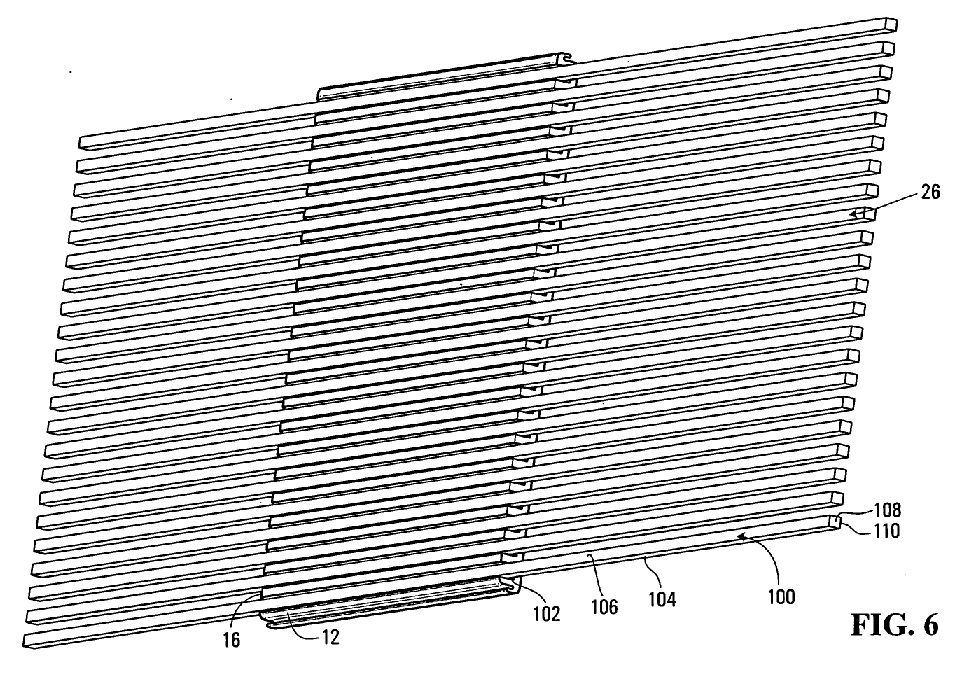

Referring to FIG. 6, in an alternative embodiment, the heat transfer elements 26 may be formed from square stock, for example, and the recesses 102 in the body 12 may have a square “U” shape. In such an embodiment, the heat transfer surfaces may comprise a plurality of generally flat surfaces 100, 104, 106, 108 and 110.

Alternatively, separate sets of rods may be installed in the recesses to extend from the first and second sides, respectively, or holes may be bored in the sides of the body to receive respective rods.

Desirably, the rods 81, shown in FIG. 5, will have a rounded shape as this shape provides a maximum ratio of heat dissipating surface to volume or mass of the rods 81. The diameter and length of the rods 81 is best optimized for the specific amount of heat energy that is required to be dissipated. It has been estimated that the diameter of cylindrically shaped aluminum rods 81 should be not less than 2 mm and not more than 6 mm in a typical solar cell application. If the diameter is less than 2 mm then the length of the rod 81 should be no more than about 180 mm as portions of the rods beyond 180 mm tend have little effect on the incremental heat dissipation due to limited longitudinal thermal conductivity. If the diameter is larger than 6 mm then the length of the rods may be increased up to 500 mm thereby increasing the total heat dissipating surface of the rods 81.

The distance between the rods 81 is set by the distance between the recesses in the body 12. It is desirable that the distance between consecutive recesses be no less than one but no more than two rod diameters. Disposing the rods within these parameters provides for sufficient air flow between the rods, while permitting a considerable number of rods to be employed.

The body 12 and rods 81 may be anodized to provide for resistance to corrosion and additional electrical resistance between the body and a heat generating component mounted thereon.

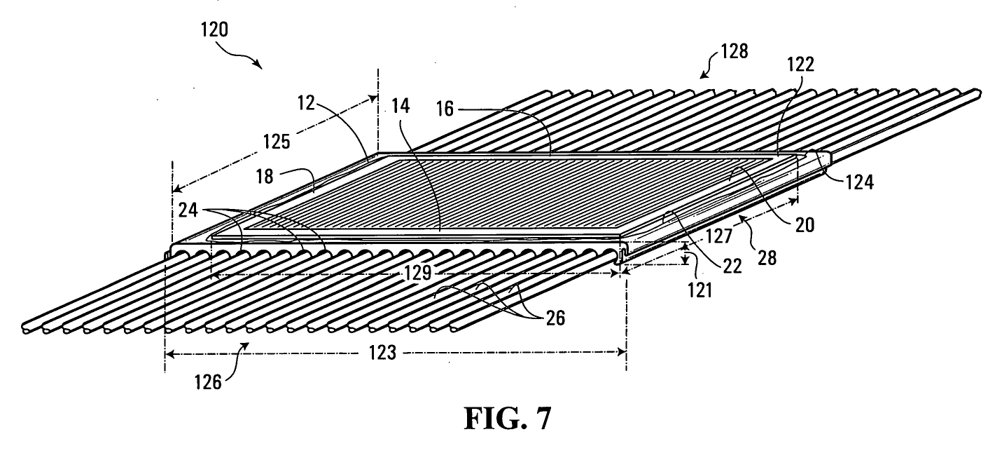

Referring to FIG. 7, a heat sinking solar cell apparatus 120 may be formed by securing a solar cell 122 to the mounting surface 22 of the body 12 described above such that the solar cell 122 is thermally coupled to the component mounting surface 22 such that heat generated by the solar cell 122 is transferred to the body 12. A thermally conductive adhesive 124 may be used to secure the solar cell 122 to the mounting surface 22, for example. Alternatively, a combination of the thermal adhesive 124 and interlayer materials such as polymeric film or non-woven or polymeric or glass fiber compounds may be used. The use of such a combination provides for both efficient heat transfer and electrical insulation between the solar cell 122 and the mounting surface 22.

The overall thickness of the thermal adhesive 124 and/or interlayer material must be kept to a minimum and preferably less than 0.3 mm to provide a low level of thermal resistance. At the same time the thickness must be sufficient to secure reliable electrical resistance between the solar cell 122 and the metallic surface of the body 12. The adhesive material 124 and/or interlayer material must also be able to tolerate the effect of high temperatures that may result during operation. Such temperatures may be in the range of between about −40 degrees Celsius to about 150 degrees Celsius, for example.

In this embodiment, the length 123 and width 125 of the body 12 are about the same as the length 127 and width 129 of the solar cell 122. The thickness 121 of the body 12 is desirably kept to a minimum to reduce thermal mass and volume of material, but must be sufficient to provide enough material to form the recesses 42, 44 and 45 and provide the mounting surface 22 with enough mechanical integrity for mounting the solar cell.

In operation, heat generated by the solar cell 122 is transferred to the body 12. Heat is then transferred from the body 12 to first and second arrays 126 and 128 of spaced apart heat transfer elements 26 which are provided by the first and second portions 80 and 82 of the rods 81 that act as the heat transfer elements 26 in this embodiment. The heat transfer elements 26 (rods 81) are thermally coupled to the body 12 and extend outwardly generally parallel to a plane of the solar cell 122, from the first and second opposite sides 14 and 16 respectively of the body 12 and fluid is permitted to pass freely between and around the heat transfer elements 26 to transfer heat from the heat transfer elements 26 to the fluid. Thus, heat generated by the solar cell 122 is dissipated, allowing the solar cell 122 to operate at lower junction temperatures, rendering it more efficient.

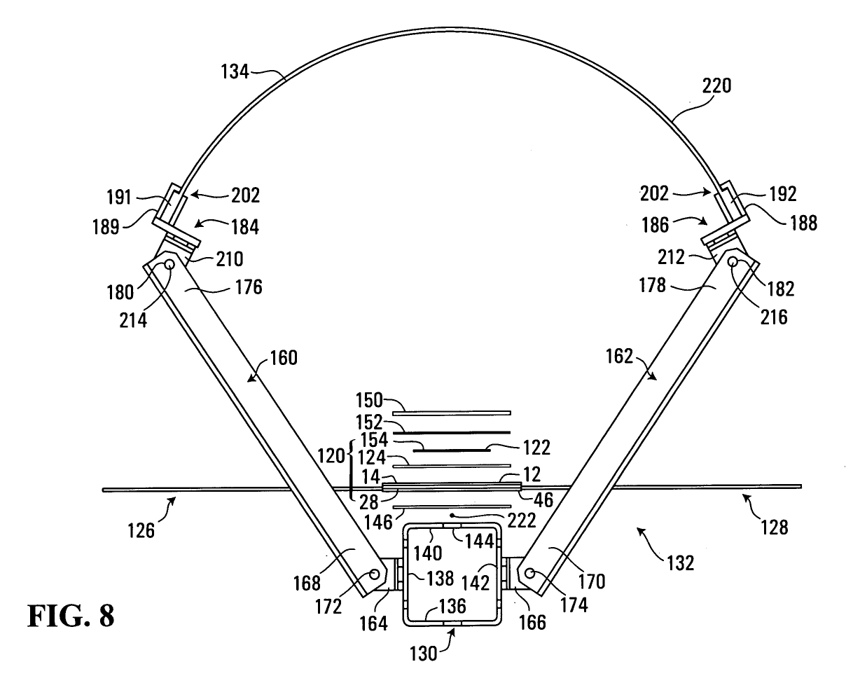

Referring to FIG. 8, the heat dissipating solar cell apparatus 120 of FIG. 7 may be mounted on a main support 130 having a lens holder 132 for holding a lens 134 to focus light energy on the solar cell 122. In this embodiment, the main support 130 includes a length of square tubing having a plurality of sides 136, 138, 140 and 142 having openings therein, one of such openings being shown at 144. The underside surface 46 of the body 12 is coupled to the main support 130 and fastened thereto by a thermally conductive adhesive 146 and/or by bolts (not shown) or other mechanical securing means. The main support 130 thus also acts to further dissipate any heat generated by the solar cell 122.

A glass plate 150 may be adhesively secured by a thermoplastic compound 152 to the top surface 154 of the solar cell 122, to protect the solar cell.

The lens holder 132 includes first and second pairs of projecting supports, the first pair being shown at 160 and 162. The projecting supports project generally away from the main support 130, at opposite ends of the main support. In the embodiment shown, T-shaped brackets 164 and 166 are secured to opposing walls 138 and 142 of the main support 130 at opposite ends of the main support. The first and second pairs of projecting supports 160 and 162 have proximal end portions only those of the first pair being shown at 168 and 170, respectively. The proximal end portions 168 and 170 are secured to respective T-shaped brackets 164 and 166 through the openings 172 and 174 to provide for pivotal movement of the projecting supports relative to the main support 130. Distal end portions 176 and 178 of the projecting supports 160 and 162 have respective openings 180 and 182 for receiving a bolt for pivotally connecting first and second lens edge holders 184 and 186 thereto.

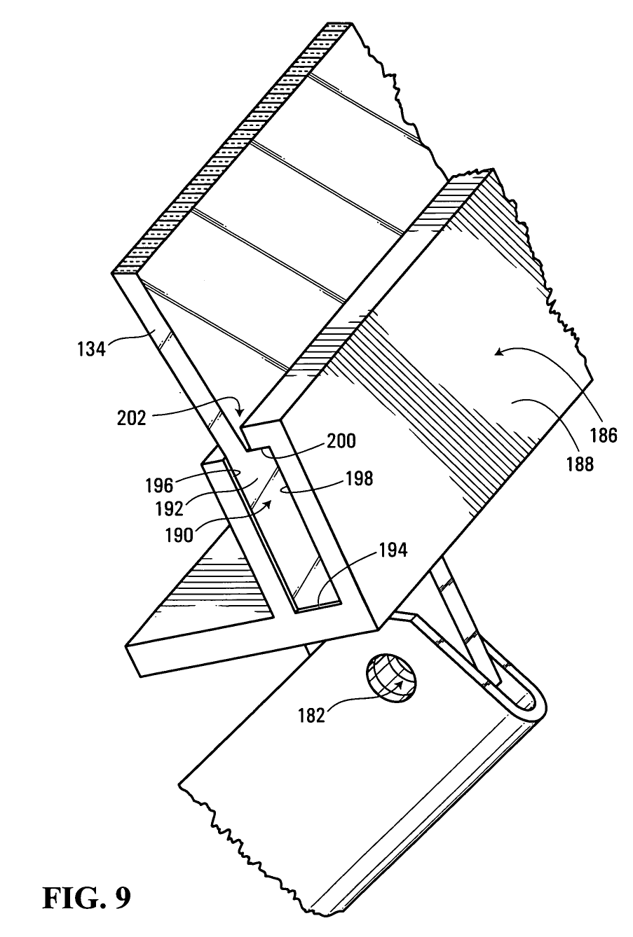

Referring to FIG. 9, in this embodiment, the first and second lens edge holders 184 and 186, only one of which is shown at 186 in FIG. 9, are comprised of channel members 188 and 189, only one of which is shown at 188, approximately the same length as the main support 130 and having a receptacle 190 for receiving and holding an edge 192 of the lens 134. The receptacle 190 may include a plurality of surfaces 194, 196, 198 and 200 formed in the channel member 188 such that a groove 202 with a captive surface (provided by surface 200) is formed, for holding a complementarily formed edge 192 of the lens 134.

Referring back to FIG. 8, each channel member 188 and 189, also has first and second depending tabs 210 and 212 having respective openings 214 and 216 for receiving respective bolts (not shown) extending through the openings 180 and 182 in the distal end portions 176 and 178 of the projecting supports 160 and 162 to pivotally secure the lens edge holders 184 and 186 to the projecting supports.

The lens 134 has first and second edges 191 and 192 with an operative portion 220 therebetween. The first and second edges 191 and 192 are formed with a shape generally complementary to the shape of the groove 202 formed in the respective lens edge holder 184 and 186 that will hold it. The lens 134 may thus be secured to the lens edge holders 184 and 186 by sliding respective edges 191 and 192 of the lens longitudinally into respective grooves 202 formed in respective lens edge holders.

In the embodiment shown, the lens 134 is a linear Fresnel lens having portions arranged in a generally convex shape and having a focal point 222 at a distance such that when the lens 134 is held by the lens holder 132, the operative portion 220 of the lens focuses solar radiation impinging thereupon onto the solar cell 122. The bolts (not shown) at each end of each projecting support 160 and 162 facilitate on-site positioning of the lens 134 relative to the solar cell 122 to permit a position of the lens 134 relative to the solar cell 122 to be adjusted even after the main support 130 has been secured to a mount (not shown).

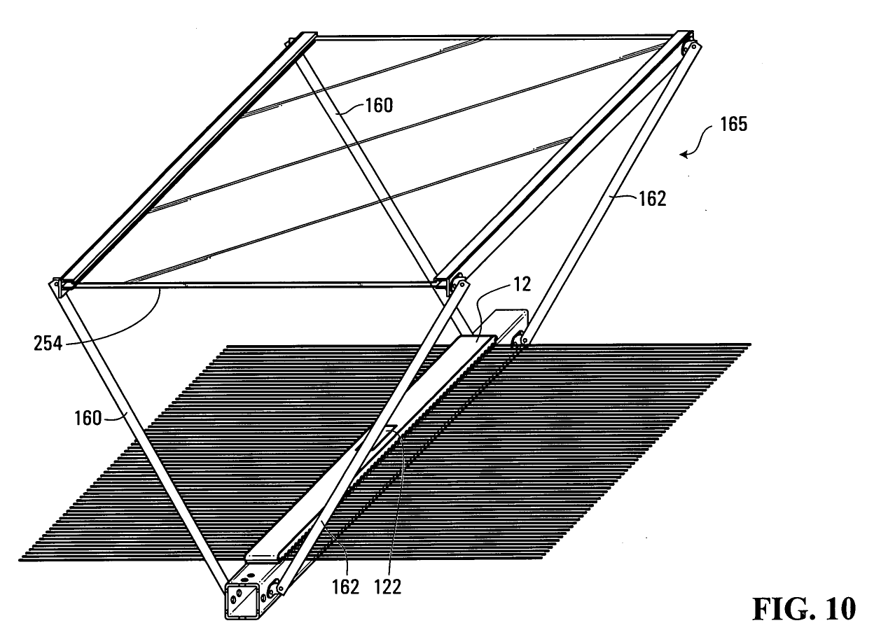

Referring to FIG. 10, in an alternative embodiment, a heat dissipating solar cell apparatus 165 includes a solar cell 122 that is relatively small compared to the body 12. This apparatus includes the same projecting supports as shown in FIG. 8 and the same lens holders as shown in FIGS. 8 and 9 except in this embodiment, the lens holders hold a planar point focussing Fresnel lens 254 to point focus the sun's energy onto the relatively small solar cell 122.

### Linear Heat Dissipating Solar Cell System

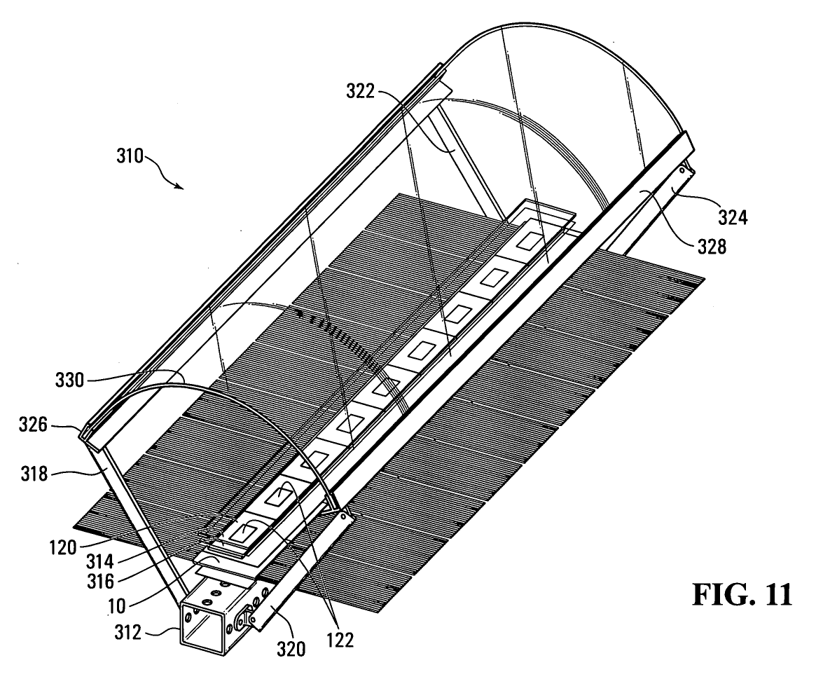

Referring to FIG. 11, a linear heat dissipating solar cell system according to another embodiment of the invention is shown generally at 310. The system may be several meters in length. The system 310 includes a plurality of heat dissipating solar cell apparatuses 120 of the type shown in FIG. 7 arranged in a line on a common support 312 and mechanically and thermally coupled together and to the common support 312. Each of the solar cells 122 are electrically connected together as well, but electrical connections have been omitted to avoid obscuring the mechanical and thermal coupling of the apparatuses. The common support 312 may be formed of galvanized square-section steel tubing, for example, and may be attached to a tracking mechanism, for example, for tracking the daily or seasonal movement of the sun in the sky. Desirably, the common support 312 is perforated to reduce mass and height and to provide for additional heat dissipation. The common support is also desirably sufficiently rigid to have no more than about a 15 mm deflection per 1 m length when a wind speed of 160 km/h is applied to the lens. To achieve the coupling of the apparatuses 120 to each other, the connectors 28 and 30 of adjacent apparatuses are connected together as shown in FIG. 4. This allows for thermal expansion of each apparatus 120 relative to its neighbours when each apparatus is heated by solar radiation. The apparatuses 120 are arranged end to end such that each heat transfer element 26 of each apparatus extends parallel to each other on opposite sides of the system 310.

The system 310 further includes a transparent glass sheet 314 extending over all of the heat dissipating solar cell apparatuses 120 to provide a moisture barrier to prevent water ingress into the solar cells. In the embodiment shown, the glass sheet 314 is coupled to the solar cells 122 by a transparent thermoplastic adhesive 316. Additional protection against moisture may be provided by metal framing (not shown) along edges of the solar cells.

First and second pairs of supports 318, 320, 322 and 324 are secured to the common support 312 as described in connection with FIG. 8 above and first and second lens edge holders 326 and 328 are secured to the first and second pairs of supports 318, 320, 322 and 324 for holding a single linear Fresnel lens 330 over all of the apparatuses within a specified length, such as one meter, for example. Transverse brackets may be used to brace respective pairs of supports, if desired.

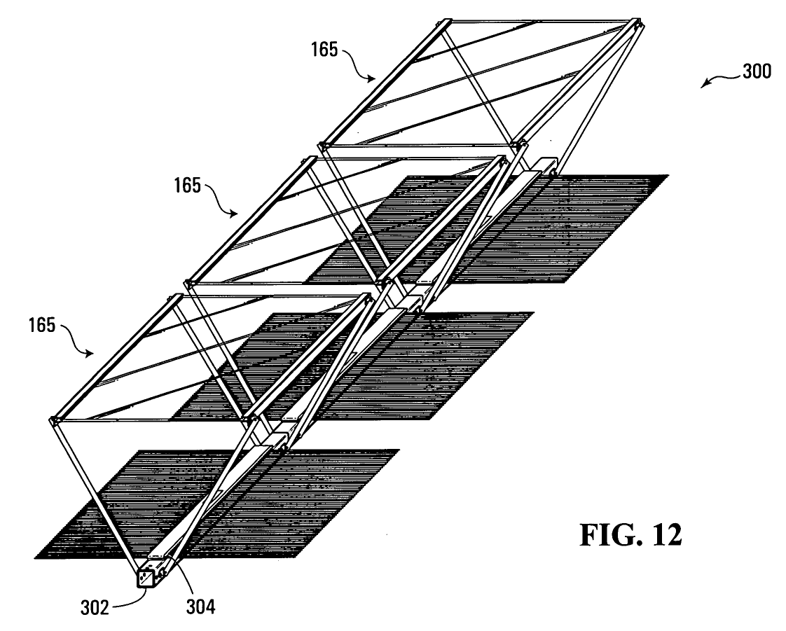

As shown in FIG. 12, a linear heat dissipating solar cell system is shown at 300 and includes a plurality of point focus concentrator apparatuses of the type shown in FIG. 10, may be coupled together linearly, by coupling respective connectors 28 and 30 of adjacent apparatuses together as shown in FIG. 4, and mounting them on a common support 302. The support 302 may include a support similar to that shown at 130 in FIG. 8, for example. The apparatuses 165 may be mounted on the support 302 using thermally conductive adhesive 304 or bolts or other mechanical securing means, for example. Each solar cell 122 is illuminated by a separate point focusing Fresnel lens of the type shown in FIG. 10.

Alternatively, a plurality of apparatuses of the type described may be arranged and coupled together in a two-dimensional array of point focus solar cell systems.

In general, the above system embodiments cooperate to provide a process for dissipating heat generated by a plurality of solar cells electrically coupled together in a linear array by causing heat generated by each solar cell to be transferred to a respective body having first and second opposite sides and first and second opposite ends, causing heat to be transferred from respective the bodies to the first and second arrays of spaced apart heat transfer elements thermally coupled to respective the bodies and extending outwardly generally parallel to respective solar cells, from the first and second opposite sides respectively of respective bodies and permitting a fluid such as ambient air to pass freely between and around the heat transfer elements to transfer heat from the heat transfer elements to the fluid while permitting the bodies to move relative to each other to provide for thermal expansion of the bodies.

It will be appreciated that the system involves the use of different materials including glass as a protective covering over the array of solar cells, silicon in the solar cells, aluminum for the bodies of the apparatuses, aluminum or steel or other metals or metal alloys, for example, for the common support 312 and adhesives, compounds and thermoplastic materials for securing various components together. Each of these materials has a different coefficient of thermal expansion and thus will expand to different lengths when the system is heated by solar energy. The connectors 28, 30 formed in the bodies 12, for connecting the bodies together are configured as described above in connection with FIG. 4 to permit thermal expansion of each apparatus individually, relative to an adjacent apparatus, which reduces stresses created between the different materials due to thermal expansion and thus reduces the risk of breaking the protective glass sheet 314 covering the linear array of solar cells or dislodging any one solar cell 122 or body 12 from the system 310 when heat is generated in the solar cell.

In addition, it should be noted that the heat dissipating rods tend not to shade each other and provide for fluid movement therebetween without entrapment of air.

A system as described above was designed, produced and tested. The Fresnel lens was one meter long and provided a 7× geometrical concentration of sunlight on a 5-cm wide and one meter long linear PV receiver array comprised of 10 solar cells, each having a length of about 10 cm, a width of about 5 cm, and a total area of about 50 cm². The light accepting aperture of the Fresnel lens was 0.35 m². The optical efficiency of the Fresnel lens was 90%. The direct component of solar radiation intensity was 970 W/m². The PV receiver-array was thus exposed to solar radiation of about 6100 W/m².

Each heat dissipating apparatus body had a width of 8 cm and a length of 10 cm size and was secured to a common support as described, using a 37 micron thermoplastic adhesive and a 37 micron interlayer of non-woven fiberglass compound. The diameter of the rods was 3.2 mm and the length of the first and second portions of the rods was 180 mm (on each side of the body) The distance between the rods was 4.5 mm. The total number of rods per meter was 220. The overall heat dissipating area of rods was 0.8 m² and the overall weight of the PV receiver array was 3 kg/m.

Field testing of the above unit was conducted at an ambient air temperature of 25 degrees Celsius and a windspeed of about 1 m/sec. Under these conditions the temperature difference between the bodies and respective solar cells did not exceed 6° C. The system proved to be sensitive to wind in that the greater the windspeed, the greater the heat dissipating capacity of the system. For example at zero wind speed a temperature differential between the solar cells and ambient was about 60° C. whereas at a wind speed of only 0.8 m/sec the temperature differential was about 28° C. At a windspeed of about 3 m/sec the temperature differential was further reduced to about 15 degrees Celsius.

From the foregoing, it will be appreciated that the ratio of heat dissipating area to solar energy collecting aperture area is about 2.3 with a heat sink weight of only 3 kg resulting in a very low ratio of mass to heat dissipating area of about 3.7 kg/m².

While specific embodiments of the invention have been described and illustrated, such embodiments should be considered illustrative of the invention only and not as limiting the invention as construed in accordance with the accompanying claims.

What is claimed is:

1. An apparatus for holding heat generating elements, the apparatus comprising:
a body having
first and second opposite sides;
first and second opposite ends;
a component mounting surface between said first and second opposite sides and said first and second opposite ends, for mounting a heat generating component thereon;
a plurality of spaced apart heat transfer element holders for holding respective heat transfer elements such that said heat transfer elements extend outwardly on opposite sides of said body, said heat transfer element holders being operably configured to transfer heat from said body to said heat transfer elements; and
at least one connector on at least one of said first and second opposite ends, operably configured to cooperate with a corresponding connector of an adjacent apparatus to mechanically couple said body to said adjacent apparatus while allowing for thermal expansion of said body relative to said adjacent apparatus.

2. The apparatus of claim 1 wherein said holders comprise recesses in said body.

3. The apparatus of claim 1 wherein said body comprises an extrusion and wherein said holders comprise respective recesses in said extrusion.

4. The apparatus of claim 3 wherein said recesses extend generally parallel to said mounting surface, between said first and second opposite sides of said extrusion.

5. The apparatus of claim 4 further comprising a plurality of spaced apart heat transfer elements held by said heat transfer element holders for transferring heat from said body to an ambient fluid.

6. The apparatus of claim 5 wherein each of said heat transfer elements has a first portion extending outwardly from said first side of said body, a second portion extending outwardly from said second side of said body and an intermediate portion extending between said first and second portions, said intermediate portion being held in a respective recess in said body.

7. The apparatus of claim 6 wherein each of said heat transfer elements comprises a fluid contacting surface for transferring heat from said heat transfer element to said fluid.

8. The apparatus of claim 7 wherein said fluid contacting surface includes a generally curved surface.

9. The apparatus of claim 8 wherein said generally curved surface includes a cylindrical surface.

10. The apparatus of claim 7 wherein said fluid contacting surface includes a plurality of generally flat surfaces.

11. The apparatus of claim 1 wherein said connector comprises a projection depending from said body in spaced apart relation relative thereto such that a space is provided between said projection and said body, whereby a projection of an adjacent similar apparatus may be received in said space to mechanically couple said body to said adjacent similar apparatus.

12. The apparatus of claim 11 wherein said projection extends generally between said first and second sides.

13. A heat sinking solar cell apparatus comprising:
a body having
first and second opposite sides;
first and second opposite ends;
a generally planar component mounting surface between said first and second opposite sides and said first and second opposite ends;
a solar cell thermally coupled to said component mounting surface such that heat generated by said solar cell is transferred to said body;
first and second arrays of spaced apart heat transfer elements thermally coupled to said body and extending outwardly on said first and second opposite sides respectively of said body and generally parallel to said component mounting surface, for transferring heat from said body to an ambient fluid.

14. The apparatus of claim 13 wherein said body comprises holders for holding said heat transfer elements.

15. The apparatus of claim 14 wherein said holders comprise recesses in said body.

16. The apparatus of claim 14 wherein said body comprises an extrusion and wherein said holders comprise respective recesses in said extrusion.

17. The apparatus of claim 16 wherein said recesses extend generally parallel to said mounting surface, between said first and second opposite sides of said extrusion.

18. The apparatus of claim 17 wherein each of said heat transfer elements has a first portion extending outwardly from said first side of said body, a second portion extending outwardly from said second side of said body and an intermediate portion extending between said first and second portions, said intermediate portion being held in a respective recess in said body.

19. The apparatus of claim 18 wherein each of said heat transfer elements comprises a fluid contacting surface for transferring heat from said heat transfer element to a fluid.

20. The apparatus of claim 19 wherein said fluid contacting surface includes a generally curved surface.

21. The apparatus of claim 20 wherein said generally curved surface includes a cylindrical surface.

22. The apparatus of claim 19 wherein said fluid contacting surface includes a plurality of generally flat surfaces.

23. The apparatus of claim 13 further comprising at least one connector on at least one of said first and second opposite ends, operably configured to cooperate with a corresponding connector of an adjacent apparatus to mechanically couple said body to said adjacent apparatus while allowing for thermal expansion of said body relative to said adjacent apparatus.

24. The apparatus of claim 23 wherein said connector comprises a projection depending from said body in spaced apart relation relative thereto such that a space is provided between said projection and said body, whereby a projection of an adjacent similar apparatus may be received in said space to mechanically couple said body to said adjacent similar apparatus.

25. The apparatus of claim 24 wherein said projection extends generally between said first and second sides.

26. A linear heat dissipating solar cell system comprising a plurality of heat dissipating solar cell apparatuses, each said apparatus being as claimed in claim 24, wherein the connectors of adjacent said apparatuses are connected together to mechanically couple said apparatuses together.

27. The solar cell system of claim 26 wherein a said projection of an apparatus is received in a said space of an adjacent apparatus and wherein said projection and said space are dimensioned to permit said projection to move in said space when said body of said apparatus or said body of said adjacent apparatus expands due to heating by a corresponding solar cell associated therewith.

28. The solar cell system of claim 27 wherein each of said plurality of heat dissipating solar cell apparatuses is thermally coupled to a common support.

29. The solar cell system of claim 28 further comprising a transparent glass sheet extending over each of said heat dissipating solar cell apparatuses and thermally coupled thereto.

30. The solar cell system of claim 29 further comprising a lens holder coupled to said common support for holding a lens to focus light energy on said heat dissipating solar cell apparatuses.

31. The solar cell system of claim 30 wherein said lens holder comprises first and second pairs of projecting supports projecting generally away from said common support, at opposite ends of said system.

32. The solar cell system of claim 31 further comprising lens edge holders for holding respective edges of said lens and wherein corresponding projecting supports of said first and second pairs of projecting supports support respective lens edge holders in parallel spaced apart relation relative to said common support.

33. The solar cell system of claim 32 further comprising a lens held by said lens edge holders.

34. The solar cell system of claim 33 wherein said lens includes a fresnel lens.

35. The solar cell system of claim 28 wherein said common support comprises a length of square tubing having a plurality of sides having openings therein.

36. A process for dissipating heat generated by a solar cell, the process comprising:
causing heat generated by the solar cell to be transferred to a body having first and second opposite sides and first and second opposite ends;
causing heat to be transferred from said body to first and second arrays of spaced apart heat transfer elements thermally coupled to said body and extending outwardly generally parallel to said solar cell, from said first and second opposite sides respectively of said body; and
permitting fluid to pass freely between and around said heat transfer elements to transfer heat from said heat transfer elements to said fluid.

37. The process of claim 36 wherein causing heat to be transferred from said body to said first and second arrays comprises causing said heat to be transferred from said body to said heat transfer elements through holders on said body for holding said heat transfer elements.

38. The process of claim 37 wherein causing said heat to be transferred through holders comprises causing said heat to be transferred from said body to respective intermediate portions of said heat transfer elements and conducting heat from said intermediate portions to opposite end portions of respective said heat transfer elements.

39. The process of claim 38 further comprising conducting said heat transferred to said opposite end portions of said heat transfer elements to surfaces of said opposite end portions of said heat transfer elements.

40. The process of claim 39 wherein conducting said heat transferred to said opposite end portions of said heat transfer elements to said surfaces of said opposite end portions comprises conducting said heat transferred to said opposite end portions to curved surfaces of said opposite end portions.

41. The process of claim 40 wherein conducting said heat transferred to said opposite end portions of said heat transfer elements to said surfaces of said opposite end portions comprises conducting said heat transferred to said opposite end portions to cylindrical surfaces of said opposite end portions.

42. The process of claim 39 wherein conducting said heat transferred to said opposite end portions of said heat transfer elements to said surfaces of said opposite end portions comprises conducting said heat transferred to said opposite end portions to generally flat surfaces of said opposite end portions.

43. The process of claim 36 further comprising mechanically coupling together a plurality of heat dissipating apparatuses, each operably configured to carry out the process of claim 36.

44. The process of claim 43 further comprising permitting bodies of said apparatuses to move relative to each other to provide for thermal expansion of said bodies.

45. The process of claim 44 further comprising permitting a first projection depending from a first body in spaded apart relation relative thereto to move in a second space provided between a second projection and a second body to provide for relative movement of said first and second bodies due to thermal expansion of at least one of said bodies while mechanically coupling said first body to said second body.

46. The process of claim 43 further comprising thermally coupling said plurality of heat dissipating solar cell apparatuses to a common support.

47. The process of claim 43 further comprising causing light to pass through a glass sheet over each of said heat dissipating solar cell apparatuses, before said light reaches said each of said heat dissipating solar cell apparatuses.

48. The process of claim 43 further comprising holding a lens in a position relative to said each heat dissipating solar cell apparatus to focus light energy on solar cells of said heat dissipating apparatuses.

49. The process of claim 48 wherein holding said lens comprises holding said lens with first and second pairs of projecting supports projecting generally away from said common support, at opposite ends of said plurality of heat dissipating solar cell apparatuses.

50. The process of claim 49 further comprising holding respective edges of said lens with respective lens edge holders supported by said first and second pairs of projecting supports.
